(19) United States
(12) Patent Application Publication
(10) Pub. No.: US 2009/0068496 A1
(43) Pub. Date: Mar. 12, 2009

(54) LED STRUCTURE

(76) Inventors: Liann-Be Chang, Tao-Yuan (TW); Chin-Huai Young, Tao-Yuan (TW); Yu-Lin Lee, Tao-Yuan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/852,461

(22) Filed: Sep. 10, 2007

(51) Int. Cl. B32B 9/00

(52) U.S. Cl. 428/702

(57) ABSTRACT

The present invention discloses an improved LED structure and comprises: a circuit brace, a bowl member; a light chip; a welding line; a packing mask; and a photocatalystic agent. The volume of an LED is smaller so as to be convenient for installment. Compared the present invention to a light tube with same power, the present invention can be added several LEDs in order to increase the curve surface area to contact air, so that the functions of disinfection, deodorization, and mildewproof can be effectively achieved.

### BACKGROUND OF THE INVENTION

1. Field of the Invention

The present invention generally relates to an improved LED structure with a photocatalystic agent. More particularly to an LED structure that causes the reaction of the photocatalystic agent in order to achieve the functions of disinfection, deodorization, and mildewproof.

2. Description of the Prior Art

Photocatalystic agent is a catalyst related to light and transformed by light energy, such transformation is a sort of chemistry. As a matter of fact, titanium dioxide (TiO₂) is the catalyst of the transformation titanium dioxide itself is an activator and with the characteristics of hyper oxidation and stability. A photocatalystic agent as titanium dioxide is powerful to resolve almost all substances and very safe. More, titanium dioxide is better than ammonia, NH₃, etc. for water treatment.

Photocatalyst is that photosynthesis similar to plant's photosynthesis is produced after titanium dioxide absorbs ultraviolet ray from sunlight or light tube. The oxidation from the photocatalyst easily resolves germs in air with 99.997%.

Photocatalystic agent has the three functions of disinfection, deodorization, and mildewproof, which are described as below:
1. Disinfection: While hydrone in air contacting with a surface treated by the photocatalystic agent and being activated by ultraviolet ray, germs in air can then be easily resolved due to the oxidation.
2. Deodorization: The most sources for NH₃ are ammonia, hydrogen sulphide, methyl mercaptide, formaldehyde, etc. Titanium dioxide which capability to oxidation is more than ammonia and NH₃, and another capability to adsorption is better than activated carbon in the aspect of resolving germs. However, such substances exist under the circumstance of titanium dioxide and can be resolved by general light sources, and titanium dioxide is capable of easily resolving hydrogen sulphide, sulfur dioxide, etc. of a cigarette, wherein such hydrogen sulphide, sulfur dioxide, and the like are carcinogen.
3. Mildewproof: Mildew is formed on a surface by mold, and the photocatalystic agent can figure out the problem very easily, such as coating the agent on a cover or wall for insulating mold, so that food can be protected in a longer duration to avoid illness, and the wall is kept clean to avoid dust.

According to aforesaid, the photocatalystic agent has the functions of disinfection, deodorization, and mildewproof, but it is only applied to light tubes so far. And the curve surface area of a light tube is smaller than an improved LED structure as an LED assemble. The inventor has developed an improved LED structure to solve the shortcomings in prior arts.

### SUMMARY OF THE INVENTION

Presently the photocatalystic agent is only applied to light tubes. And the curve surface area of a light tube is smaller than an improved LED structure as an LED assemble, which has a plurality of LEDs. Therefore, the surface area of a light tube to contact air is very limited, and thus the oxidation from the light tube is not enough as requested.

The main objective of the present invention is to provide an improved LED structure, which is to increase the curve surface area in order to contact air. The improved LED structure comprises: a circuit brace having a first conductive portion and a second conductive portion thereon, a bowl member being disposed on the first conductive portion toward the circuit brace; a light chip being connected to the inner bottom surface of the bowl member for electrically connecting to the first conductive portion; a welding line, which one end is electrically connected to the light chip, another end is electrically connected to the second conductive portion; a packing mask being covered on the first conductive portion and the second conductive portion; and a photocatalystic agent being coated on the outer surface of the packing mask, and having the capability of causing hyper oxidation, stability, and safety.

The volume of an LED is smaller so as to be convenient for installment. Compared the present invention to a light tube with same power, the present invention can be added several LEDs in order to increase the curve surface area to contact air, so that the functions of disinfection, deodorization, and mildewproof can be effectively achieved.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic 3-D view of a preferred embodiment of the present invention;

FIG. 2 illustrates a schematic side view of the preferred embodiment of the present invention;

FIG. 2A illustrates a schematic top view of the preferred embodiment of the present invention;

FIG. 3 illustrates a schematic view of a chain reaction of a photocatalystic agent of the present invention;

FIG. 4 illustrates a schematic view of a broken-line graph of ultraviolet and NOₓ;

FIG. 5 illustrates a schematic view of a broken-line graph of a recovering rate while eliminating NOₓ;

FIG. 6 illustrates a schematic view of a structure of metal-oxide and binder;

FIG. 7 illustrates a schematic comparison view of larger particles and smaller particles while degrading the concentration of methylene blue; and

FIG. 8 is a table related to the concentration, duration, and total lowering rate of the present invention eliminating formaldehyde.

### DETAILED DESCRIPTION OF THE INVENTION

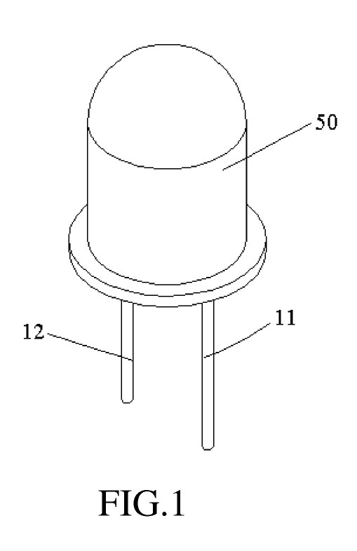

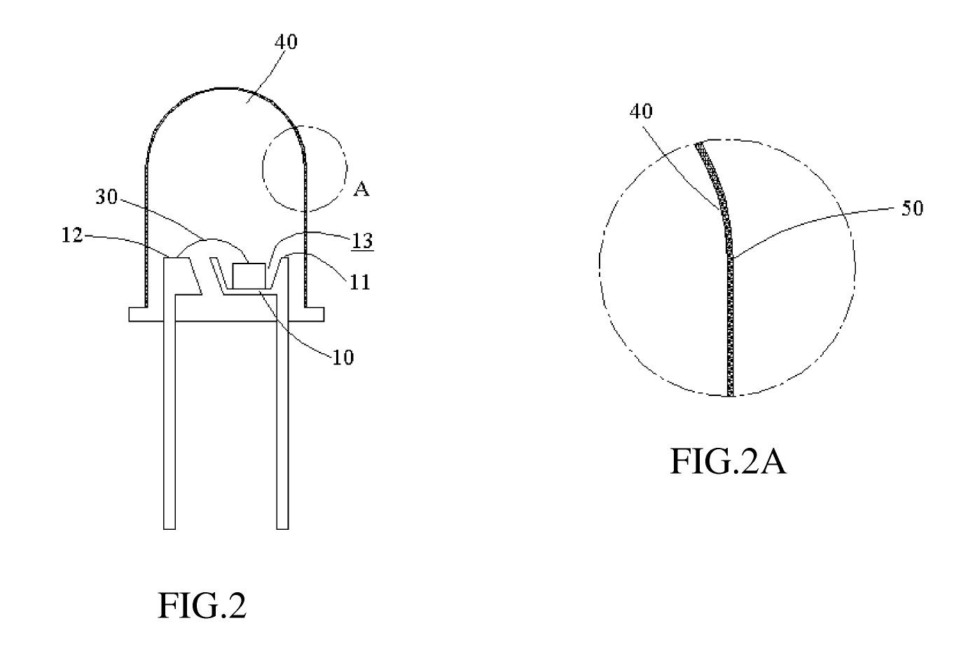

The present invention is an improved LED structure, which has a photocatalystic agent. With reference to FIG. 1, FIG. 2, and FIG. 2A, the improved LED structure includes:
a circuit brace having a first conductive portion 11 and a second conductive portion 12 thereon, a bowl member 13 being disposed on the first conductive portion 11 toward the circuit brace;
a light chip 20 being connected to the inner bottom surface of the bowl member 13 for electrically connecting to the first conductive portion 11;
a welding line 30, which one end is electrically connected to the light chip 20, another end is electrically connected to the second conductive portion 12;
a packing mask 40 being covered on the first conductive portion 11 and the second conductive portion 12; and
a photocatalystic agent 50 being coated on the outer surface of the packing mask 40, and having metal-oxide so as to have the capabilities of higher oxidation, stability, and safety.

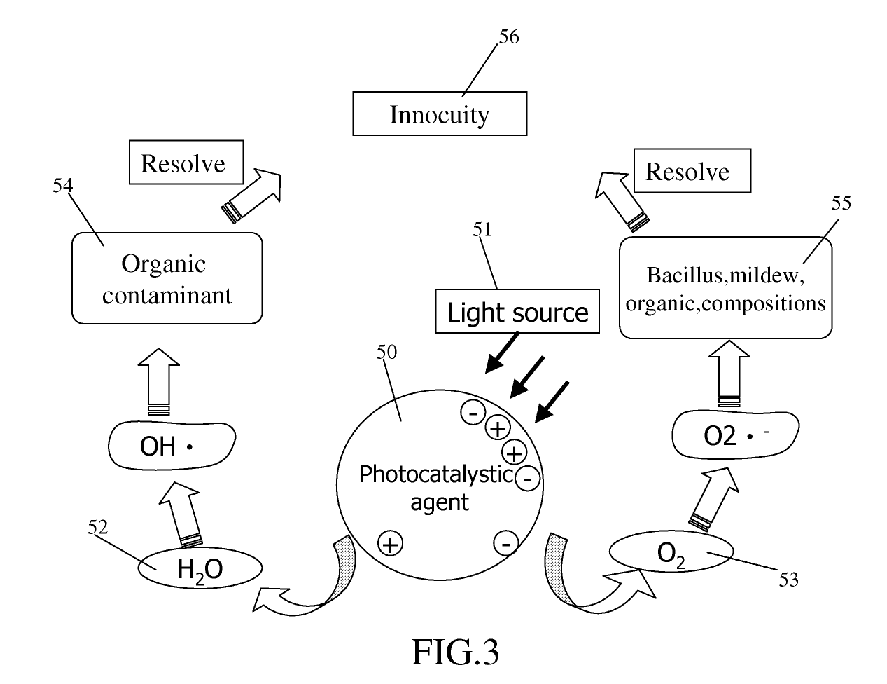

With reference to FIG. 2, FIG. 2A, and FIG. 3, the light chip 20 projects light 51 to the photocatalystic agent 50 on the packing mask 40. The photocatalystic agent 50 resolves H₂O (hydrone) 52 to OH (hydroxyl ions) and O₂ 53, so that a higher oxidation is reacted in order to resolve organic contaminant 54 into innocuity 56, wherein the O2 53 is able to resolve organic compositions 55 as bacillus, mildew, etc. into the innocuity 56.

The volume of the LED structure of the present invention is small in order to be convenient for installment. Further that, compared the present invention with a light tube with same power, the present invention may have several LEDs so as to increase the curve surface area thereof that is larger than the curve surface area of the light tube. Hence, the present invention has a larger surface area to contact with air in order to achieve better effects in disinfection, deodorization, and mildewproof.

Due to public places of entertainment as KTV, liquor shop, etc. accommodating guests with smoking cigarettes, drinking wine, etc., such places may have disgusting smelling caused by aforesaid behaviors. Applying the present invention to such places may solve the worse conditions; and more over, the present invention can be made as Christmas light, which prettified the environment as well.

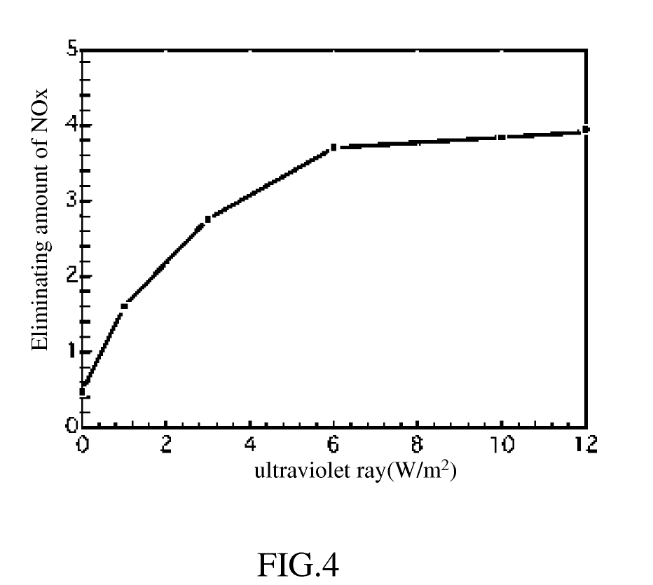

With reference to FIG. 4, which illustrates a schematic view of a broken-line graph of ultraviolet and NOₓ. According to FIG. 4, the eliminating amount of NOₓ is proportional to the strength of ultraviolet.

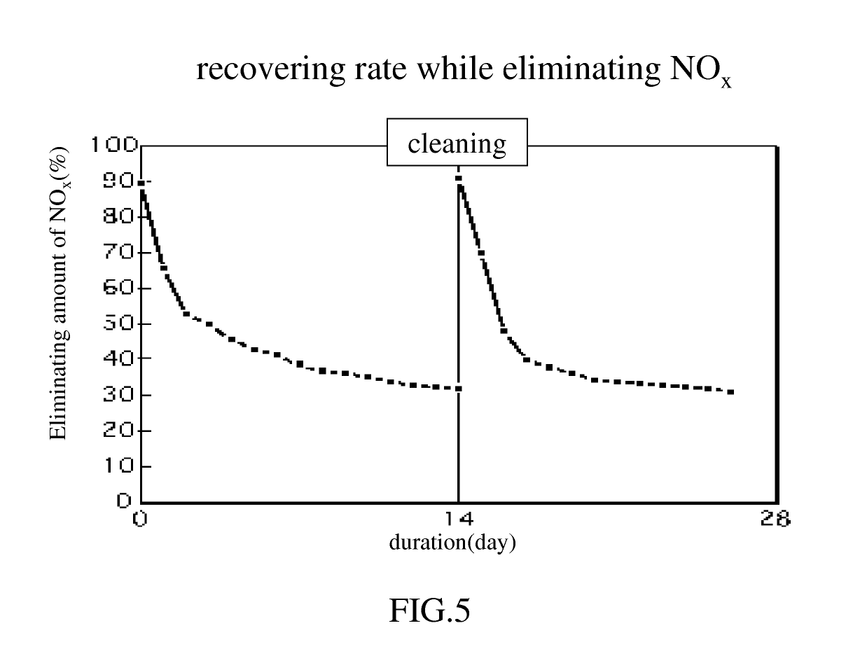

With reference to FIG. 5, which illustrates a schematic view of a broken-line graph of a recovering rate while eliminating NOₓ. That is, from day 0 to day 14, the capability to eliminate NOₓ is gradually worse while continuously using the present invention; the capability can be recovered after cleaning the present invention, in another word, the day after day 14.

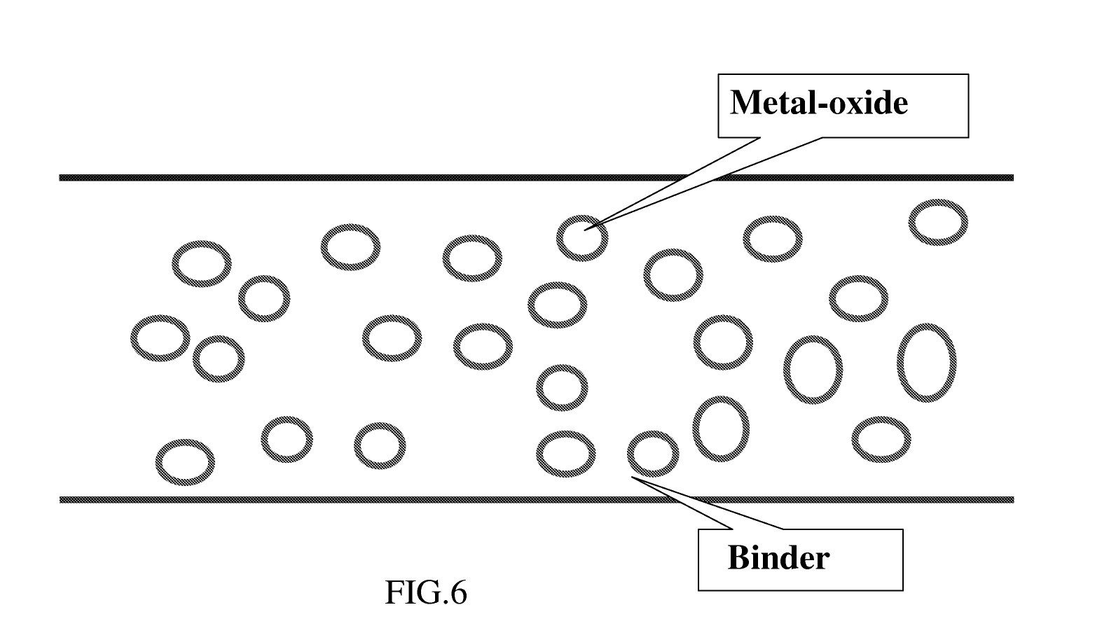

With reference to FIG. 6, which illustrates a schematic view of a structure of metal-oxide and binder.

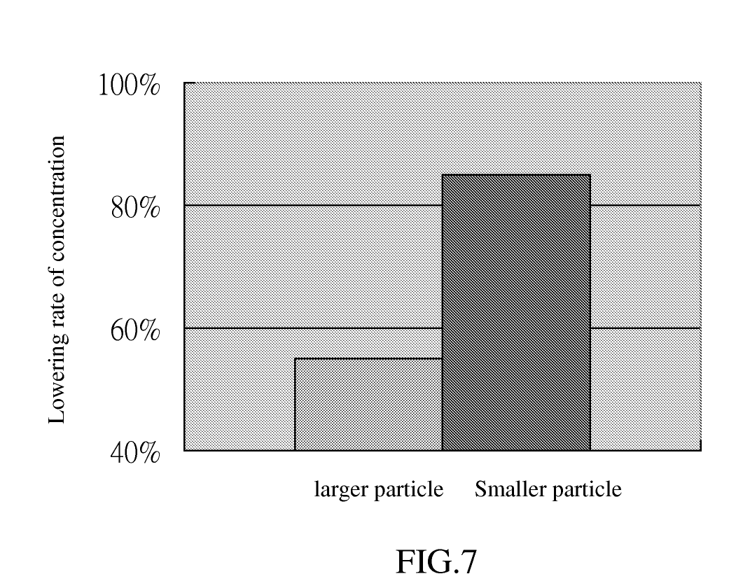

With reference to FIG. 7, which illustrates a schematic comparison view of larger particles and smaller particles while degrading the concentration of methylene blue. In accordance with FIG. 7, the lowering rate of the concentration with smaller LEDs is higher than the lowering rate of the concentration with larger LEDs. That is, the total curve surface area of the smaller LEDs is larger than the total curve surface area of the larger LEDs.

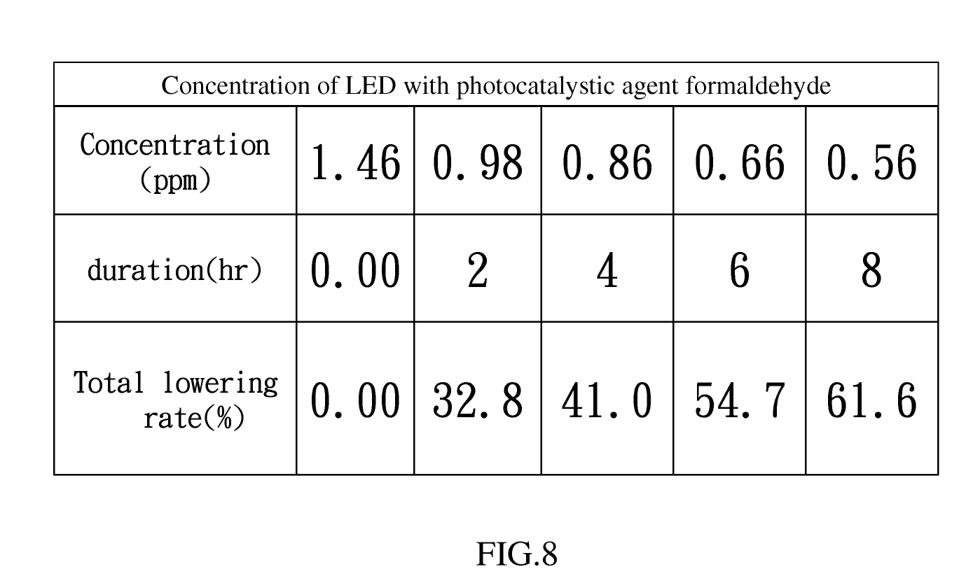

With reference to FIG. 8, which is a table related to the concentration, duration, and total lowering rate of the present invention eliminating formaldehyde. According to FIG. 8, the total lowering rate is proportional to the duration.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. An improved LED structure comprising:
a light chip having a first conductive portion and a second conductive portion;
a welding line, which one electrical end being connected to the light chip, another end being electrically connected to the second conductive portion;
a packing mask being covered on the light chip; and
a metal-oxide coating on the outer surface of the packing mask for disinfection, deodorization, and mildew proofing of a workpiece.

2. The improved LED structure according to claim 1, wherein the has metal-oxide is titanium dioxide.
